(19) United States
(12) Patent Application Publication
(10) Pub. No.: US 2025/0105569 A1
(43) Pub. Date: Mar. 27, 2025

(54) A LOCKING ELEMENT

(71) Applicant: SIGNIFY HOLDING B.V., EINDHOVEN (NL)

(72) Inventors: VINCENT ANTOINE JOSEPHUS LUIJCKS, SON EN BREUGEL (NL); ZHIPEI WANG, SHANGHAI (CN); MARTIJN HENRI RICHARD LANKHORST, EINDHOVEN (NL); ADRIANUS MARIA GOIJAERTS, EINDHOVEN (NL)

(21) Appl. No.: 18/832,192

(22) PCT Filed: Feb. 3, 2023
(86) PCT No.: PCT/EP2023/052722

§ 371 Date: Jul. 23, 2024

(30) Foreign Application Priority Data
Feb. 8, 2022 (WO) PCT/CN2022/075565
Mar. 31, 2022 (EP) 22165988.1

(51) Int. Cl. H01R 33/97; F16B 21/02; H01R 13/627

(52) U.S. Cl. CPC H01R 33/971; F16B 21/02; H01R 13/627

(57) ABSTRACT

The invention provides an assembly comprising a locking element and a plug module (20) connected to a socket (30); the locking element (10) comprising: a fastening means (12) configured to constrain a rotation of the locking element around the centerline of the socket; a main body (13) comprising a circumference; at least one spring plate (11) coupled to the main body and freely extending along a part of said circumference; wherein the at least one spring plate is deflectable between an initial position and a deflected position, wherein in the initial position the at least one spring plate protrudes in the axial direction of the centerline, the at least one spring plate being configured to engage a base surface of the plug module and to deflect away from said initial position into the deflected position, thus enabling the rotational movement of the plug module in the first rotational direction.

### FIELD OF THE INVENTION

The invention relates to a locking element for releasably locking a plug module connected to a socket. The invention further relates to an assembly comprising a lighting device, a socket, a plug module, and said locking element. Hence, the plug module according to the present application may relate to modules being used in the domain of professional lighting. The invention further relates to a plug module, a method, and a kit of parts. The invention further relates to a luminaire comprising a socket and said locking element.

### BACKGROUND OF THE INVENTION

A relevant development in the professional lighting domain is that professional lighting solutions become smart, and more and more connected to other devices. Such other devices may for example be sensor modules, that control the operation of a lighting device, or for example be communication modules that convey information.

Such lighting solutions may therefore be equipped with a dedicated connection/communication interface. One example thereof is the Zhaga interface, which not only provides a connector addressing industry-wide interchangeability of components, but also addresses interoperability of electrical components and interfaces, including sensors and communication modules.

For example, the ZhagaBook18 connector is commercially available, and provides a standardized connector and interface for connecting additional devices to a luminaire. These additional devices may for example be sensors, sensor bundles, communication modules, or any other smart electronic device interacting with a lighting device. Such additional devices may also be referred to as Zhaga modules or Zhaga nodes.

Thereby, the standardized Zhaga connector consists of a dedicated Zhaga socket and a Zhaga module equipped with a corresponding Zhaga plug, e.g. at a base surface thereof, wherein the Zhaga module is mechanically connected and fixed to the Zhaga socket by a push action & clockwise rotation. Said fixation is caused a press fit. Disconnecting is similarly done, namely by a push (to force the module out of the press fit) & counterclockwise rotation.

This connection and disconnection behavior may mutatis mutandis apply to a standardized NEMA connector/interface as well, having an associated NEMA plug and NEMA socket. The NEMA socket is also widely implemented to connect additional devices to a lighting device, such as sensors.

Therefore, the Zhaga connector, the NEMA connector, and also other similar connectors and mechanical interfaces in the professional lighting domain, may facilitate the connection and disconnection of additional devices (e.g. sensor modules) by a straightforward rotational movement, and without the use of any dedicated tooling. This also renders that any person can easily disconnect and steal such additional devices from lighting devices equipped with them.

This is mitigated by only equipping high-bay luminaires, such as street poles, with such connectors and mechanical interfaces for connecting additional devices. It has namely been proven that unreachable luminaires are less prone to theft. However, such connectors and mechanical interfaces are also increasingly being applied to low-bay luminaires, for example in parking garages.

Therefore, for certain lighting applications with a low installation height (e.g. up to 2 meters), the problem of theft of said additional devices (that are connected to the luminaire) may still exist. Hence, a clear need exists to releasably lock additional devices to lighting devices (such as low-bay luminaires) that are making use of freely connectable/disconnectable connectors.

U.S. Pat. No. 4,477,143A discloses a twist-lock type receptacle that can be assembled into a luminaire. The receptable is retained in an aperture through the luminaire housing by a snap ring holding the receptacle resiliently down against the housing. By lifting up the receptable, keying pins in the receptacle and housing are disengaged and the receptable may be turned to a different orientation. Such an example does however not lock the receptable to the luminaire as turning to different orientations is enabled.

### SUMMARY OF THE INVENTION

It is an object of the invention to provide an improved assembly, method, luminaire, and/or locking element, which at least alleviates the problems and disadvantages mentioned above.

The present invention is defined by the appended independent claims and dependent claims.

Thereto, the invention provides a locking element for releasably locking a plug module connected to a socket; wherein the socket is positionally fixed and comprises a centerline; wherein the plug module is mechanically connectable to the socket with a press fit connection ensued by a rotational movement of the plug module in a first rotational direction around the centerline of the socket; wherein the locking element comprises: a fastening means configured to constrain a rotation of the locking element around the centerline of the socket; a main body comprising a circumference; at least one spring plate coupled to the main body and freely extending along a part of said circumference; wherein the at least one spring plate is deflectable between an initial position and a deflected position, wherein in the initial position the at least one spring plate protrudes in the axial direction of the centerline; wherein, when the plug module is being mechanically connected to the socket, the at least one spring plate is configured to engage a base surface of the plug module and to deflect away from said initial position into the deflected position, so as to enable the rotational movement of the plug module in the first rotational direction; wherein, when the plug module is mechanically connected to the socket, the at least one spring plate is configured to spring back to the initial position and to engage a structure of the base surface of the plug module, so as to prevent a rotational movement of the plug module in a second rotational direction opposite to the first rotational direction.

Thereto, the invention provides said locking element, wherein the at least one spring plate may be arranged at least 90 millimeters from the centerline.

The present invention provides a locking element comprising a fastening means to constrain the rotation of the locking element around the centerline of the socket, a main body comprising a circumference, and at least one spring plate coupled to the main body and freely extending along a part of said circumference.

Therefore, the rotation of the locking element (and corresponding main body) is also positionally fixed, relative to the socket and the centerline of the socket. Moreover, the at least one locking element is deflectable between an initial position and a deflectable position. The at least one spring plate deflects into the deflected position when a base surface of the plug module engages therewith, while the plug module is being mechanically connected to the socket. Since the locking element—by means of the deflectable at least one spring plate-enables the rotational movement of the plug module in the first rotational direction, the plug module can be allowed to connect to the socket.

However, the deflectable at least one spring plate springs back to the initial position to engage a structure of the base surface of the plug module, when the plug module is mechanically connected to the socket. The latter alternatively phrased: at the moment when the plug module is mechanically connected to the socket. This prevents the plug module to rotate in the second rotational direction opposite to the first rotational direction. Consequently, the locking element locks the plug module to the socket, because a disconnecting rotation of the plug module in the second rotational direction is no longer possible.

All in all, since the at least one spring plate remains deflectable, another tool forcing or deflecting the at least one spring plate may release the plug module from a locked position when mechanically connected to the socket (or: after being mechanically connected to the socket). The present invention therefore advantageously provides a locking element that enables releasably locking of the plug module connected to the socket. The plug module cannot be disconnected from the socket unless a dedicated tool is used to force or deflect each of the at least one spring plate.

Moreover, no additional or significant modifications are required on the socket or the plug module, as a third object, namely the locking element, may facilitate said releasably locking mechanism as described in the present application.

Moreover, the at least one spring plate engaging the structure of the base surface of the plug module applies to a plug module comprising such a structure. Such a plug module may be named, for convenience, a proprietary plug module. Since the lighting market may allow plug modules that do not comprise such a structure, the locking element according to the invention should not interfere with such plug modules without a structure of the base surface. Such a plug module may be named, for convenience, a third-party plug module. The present invention is particularly advantageous, because the at least one spring element is deflectable and does not spring back to the initial position to engages said structure if said structure is not present on the base surface, which may for example be the case for a ‘third party plug module’. Hence, such a ‘third party plug module’ may be freely connected and disconnected to a socket assembled with a locking element, and only the ‘proprietary plug modules’ with a structure may be releasably locked.

All in all, any plug module (of any supplier) that is compliant to connect to said socket may thereby be allowed to connect and disconnect to said socket. The deflectable nature of the at least one spring plate may facilitate this, while only the plug modules comprising said structure of said base surface may engage in the releasably locking mechanism according to the invention.

Said at least one spring element freely extending along a part of said circumference may be defined as along a part of said circumference at any height relative to the axial direction of the centerline. Hence, the at least one spring element may freely extend along a part of said circumference, while extending away from said main body along the axial direction of the centerline. Hence, the at least one spring element may follow a helical path along a hypothetical cylinder with the same length axis as the centerline and effective diameter and/or cross section of the circumference.

Moreover, said at least one spring element protruding in the axial direction of the centerline may, in aspects, be defined as protruding in the axial direction of the centerline under an angle relative to a plane enclosed by the circumference. Said angle may for example be 45 degrees, 30 degrees, 90 degrees, between 25 and 90 degrees.

As mentioned, since the at least one spring plate remains deflectable, another tool forcing or deflecting the at least one spring plate may release the plug module from a locked position when mechanically connected to the socket. Hence, in an embodiment, when the plug module is mechanically connected to the socket and the at least one spring plate is in the initial position, the at least one spring plate may be configured to receive a tool for deflecting the at least one spring plate to the deflected position, so as to enable the rotational movement of the plug module in the second rotational direction.

In aspects thereof, the at least one spring may be configured to receive a tool for deflecting simultaneously or consecutively each spring plate of the at least one spring plate to the deflected position. Hence, when the locking element comprises four spring plates, for example, said tool may simultaneously or consecutively deflect or force each spring plate into the deflected position, so as to allow the plug module to rotate in the second rotational 25 direction for disconnecting from the socket.

In an embodiment, the socket may be a Zhaga socket; and the plug module may be a Zhaga node. In other words, the Zhaga node may be a Zhaga module or Zhaga plug module, and the Zhaga socket may be referred as a Zhaga receptacle. Such a connector May be widely used in the professional lighting domain and may cope with theft problems, as it is freely disconnectable. Hence, the present invention may solve said problems especially for Zhaga.

In an embodiment, the socket may be a NEMA socket; and the plug module may be a NEMA node. In other words, the NEMA node may be a NEMA module or NEMA plug module, and the NEMA socket may be referred as a NEMA receptacle. Such a connector may be widely used in the professional lighting domain and may cope with theft problems, as it is freely disconnectable. Hence, the present invention may solve said problems especially for NEMA.

In an embodiment, the main body may comprise the fastening means, wherein the fastening means may be a protrusion protruding towards the centerline of the socket, wherein the protrusion may be configured to constrain, when interlocked with a slot of the socket, the rotation of the locking element around the centerline of the socket. Said protrusion may be a ridge or a nudge. Said protrusion may be a pin or bearing. Said slot may alternatively be a groove, or an opening, or a hole.

In aspects, said protrusion may be configured to interlock with a groove of the socket. Hence the socket may comprise a groove. For example, the Zhaga socket comprises a groove to fixate a rotation of the Zhaga socket relative to the surface onto which it is mounted, such as a surface of a luminaire.

In another, opposite, embodiment, the main body may comprise the fastening means, wherein the fastening means may be a slot configured to interlock with a protrusion if the socket, wherein the protrusion may be configured to constrain, when interlocked with said protrusion of the socket, the rotation of the locking element around the centerline of the socket.

In an embodiment, the main body may comprise the fastening means, wherein the fastening means may be an adhesive layer. For example, the adhesive layer may be arranged to adhere to the socket and/or to a surface to which the socket is fixed, e.g. a surface of a lighting device or luminaire.

In an embodiment, the main body may comprise the fastening means, wherein the main body may comprise an inner aperture, wherein the fastening means may be an inner circumferential surface of the inner aperture of the main body, wherein the inner circumferential surface of the main body is configured to be press-fitted to the socket, so as to constrain a rotation of the locking element around the centerline of the socket. Hence, the diameter of the inner aperture may be configured to match the diameter of the socket.

In an embodiment, the main body is a plate-shaped ring. Hence, the main body may be a plate. Hence, the main body may be circular. For example, the main body may comprise a thickness of at most 1 centimeter, preferably at most halve a centimeter. In examples, the main body may comprise a circular (inner) aperture arranged to receive said socket. The socket may thus protrude though said aperture, such that the main body may encircle the socket. Said circular aperture may for example be at least 40 millimeters. Such a value of 40 millimeters may associate well with the gasket area of a Zhaga compliant socket.

In further examples, the main body may be rectangular or polygonal. In aspects, the main body may also comprise a circular aperture for such examples. In further examples, the main body may comprise an arc-shape.

In an embodiment, the at least one spring plate may be only one spring plate. Said spring plate may be coupled to said main body at a first coupling edge and/or a second coupling edge. Said spring plate may comprise an arc shape, for example extending along a halve of said circumference. Thus, said first coupling edge and said second coupling edge may be at antipodal points of said circumference.

In an embodiment, the at least one spring plate may comprise a plurality of spring plates. In an embodiment, the at least one spring plate comprises a plurality of spring plates evenly spaced around the circumference of the main body. In an embodiment, the at least one spring plate comprises at least three spring plates. In an embodiment, the at least one spring plate comprises four spring plates. Said four spring plates may be evenly spaced. In an embodiment, the at least one spring plate may comprise a spring plate material, wherein said spring plate material comprises a metal and/or a polymer. Said metal may for example be stainless steel or aluminum. Said metal may for example be brass.

In an embodiment, the locking element may be concentric with the socket. Hence, the locking element may surround the socket. The locking element may also be interlocked with the socket, so as to fixate the rotation of the locking element around the centerline of the socket. Hence, the locking element may for example be a ring arranged to be mounted around the socket.

In an embodiment, the main body comprises a circular shape. In an embodiment, said circular shape comprises a diameter of at least 90 millimeter. In an embodiment, said circumference is circular and said circumference is arranged at a diameter of at least 90 millimeter relative to the centerline. Said value of 90 millimeter may demarcate the keep-out area of the Zhaga connector. Thus, said at least one spring plate may not enter the keep-out area of the Zhaga connector.

Hence, the at least one spring plate may be arranged at least 90 millimeters from the centerline, and/or only extend into an area at least 90 millimeter away from the centerline.

As mentioned, the at least one spring plate is coupled to the main body and is freely extending along a part of said circumference. In an embodiment, said part of said circumference is at most a quarter of said circumference.

It is further an object of the invention to provide an improved assembly according to the invention. Thereto, the invention provides, an assembly comprising a lighting device, a socket, a plug module, and a locking element according to the invention; wherein the socket is positionally fixed to said lighting device; wherein the plug module comprises a base surface comprising a structure; wherein the plug module is configured to mechanically connect to the socket with a press fit connection ensued by a rotational movement of the plug module in a first rotational direction around the centerline of the socket; wherein, when the plug module is being mechanically connected to the socket, the at least one spring plate of the locking element is configured to engage the base surface of the plug module and to deflect away from said initial position into the deflected position, so as to the rotational movement of the plug module in the first rotational direction; wherein, when the plug module is mechanically connected to the socket, the at least one spring plate of the locking element is configured to spring back to the initial position and to engage the structure of the base surface of the plug module, so as to prevent a rotational movement of the plug module in a second rotational direction opposite to the first rotational direction. Thereby, advantages and/or embodiments applying to the locking element according to the invention may mutatis mutandis apply to said assembly according to the invention. Said assembly may alternatively be phrased as a lighting assembly, or lighting system.

Hence, the present invention may further provide a plug module according to the invention. Thereto, the invention may provide a plug module comprising a base surface comprising a structure; wherein the plug module is configured to mechanically connect to the socket according to the invention with a press fit connection ensued by a rotational movement of the plug module in a first rotational direction around the centerline of the socket; wherein the plug module is configured to engage with the locking element of the present invention. Said plug module may for example be a Zhaga plug module. Hence, said plug module may comprise a Zhaga plug.

According to the present invention, said structure of the base surface of the plug module may for example be a respective at least one rib or a respective at least one hole. Hence, a spring plate of the at least one spring plate may engage said respective rib of the at least one rib or engage (or: spring into) said respective hole of the at least one hole, so as to prevent a rotational movement of the plug module in the second rotational direction opposite to the first rotational direction.

Said at least one rib may be arranged radially (or: arranged extending in radial direction) relative to the centerline. Said base surface of the plug module may further comprise a groove. Said groove may extend in radial direction relative to the centerline.

Throughout the application, said base surface of the plug module may face the locking element when the plug module is being connected to the socket, or when the plug module is connected to the socket. Throughout the application, said at least one spring plate may face the base surface of the plug module when the plug module is being connected to the socket, or when the plug module is connected to the socket.

Hence, albeit not claimed as part of the invention, the invention may provide a plug module comprising a base surface, a structure, and a Zhaga plug; wherein plug module is configured to mechanically connect to a Zhaga socket with a press fit connection ensued by a rotational movement of the plug module in a first rotational direction around a centerline of the socket; wherein the base surface comprises said structure; wherein the structure comprises at least one rib or at least one groove, wherein the at least one rib or at least one groove extends in radial direction relative to said centerline, wherein the at least one rib or the at least one groove are configured to engage a respective at least one spring plate of a locking element, so as to prevent, when engaged with said respective at least one spring plate, a rotational movement of the plug module in a second rotational direction opposite to said first direction. Hence, said Zhaga plug and said Zhaga socket may be electrically connected due to said mechanical connection. Hence, the Zhaga plug may be configured to electrically connect to an electrical receptacle of the socket.

Said lighting device may be a luminaire. Said lighting device may comprise a surface, wherein the socket is positionally fixed to said surface. Said luminaire may be low-bay luminaire.

It is further an object of the invention to provide an improved method according to the invention. Thereto, the invention provides a method of releasably locking a plug module connected to a socket with the locking element according to the invention; wherein the socket is positionally fixed and comprises a centerline; wherein the plug module is mechanically connectable to the socket with a press fit connection ensued by a rotational movement of the plug module in a first rotational direction around the centerline of the socket; wherein the method comprises: constraining a rotation of the locking element around the centerline of the socket; when the plug module is being mechanically connected to the socket, the at least one spring plate of said locking element engaging a base surface of the plug module and deflecting away from said initial position into the deflected position, for enabling the rotational movement of the plug module in the first rotational direction; when the plug module is mechanically connected to the socket, the at least one spring plate springing back to the initial position and engaging a structure of the base surface of the plug module, for preventing a rotational movement of the plug module in a second rotational direction opposite to the first rotational direction. Thereby, advantages and/or embodiments applying to the locking element or assembly according to the invention may mutatis mutandis apply to said method according to the invention.

In an embodiment, when the plug module is mechanically connected to the socket and the at least one spring plate is in the initial position, the at least one spring plate receiving a tool for deflecting the at least one spring plate to the deflected position, for enabling the rotational movement of the plug module in the second rotational direction. It is further an object of the invention to provide an improved kit of parts according to the invention. Thereto, the invention provides a kit of parts comprising a tool and the locking element according to the invention; wherein the tool comprises at least one arm; wherein, in operation, each arm of the at least one arm is configured to engage, in operation, each respective spring plate of the at least one spring plate of the locking element for deflecting each spring plate of the at least one spring plate into the deformed position; wherein the at least one spring plate is a plurality of spring plates, and the at least one arm is a plurality of arms. Thereby, advantages and/or embodiments applying to the locking element, method, or assembly according to the invention may mutatis mutandis apply to said kit of parts according to the invention.

It is further an object of the invention to provide an luminaire according to the invention. Thereto, the invention provides a luminaire comprising a light source, a controller, a luminaire surface, a socket and a locking element according to the invention; wherein said socket is positionally fixed on the luminaire surface; wherein said socket is arranged for mechanically connecting to a plug module; wherein the socket is configured to connect to a plug module and convey control signals between the plug module and the controller; wherein the controller is configured to control the light source at least partly based on the control signals; wherein the locking element is configured to releasably lock the plug module connected to the socket for preventing disconnection of the plug module and ensuring the control signals to be conveyed.

Since the plug module conveys control signals to the controller, at least partly based on which the controller controls the light source of the luminaire, it is desired to maintain the mechanical connection between the plug module and the socket. Hence, the locking means according to the invention is advantageous in enabling the proper functioning of the luminaire in controlling said light source. Said plug module may be a Zhaga module or NEMA module. Said socket may be a corresponding Zhaga socket or NEMA socket. Hence, the invention may provide a luminaire comprising a Zhaga socket with a locking means according to the present invention/application. It is noted that Zhaga interface has no such locking mechanism. The present invention is therefore clearly advantageous.

### BRIEF DESCRIPTION OF THE DRAWINGS

The invention will now be further elucidated by means of the schematic non-limiting drawings:

FIGS. 1-3 depict schematically an embodiment of an assembly according to the invention;

FIG. 4 depicts schematically an embodiment of a tool according to the invention for unlocking a plug module of the assembly depicted in FIGS. 1-3;

FIG. 5 depicts schematically a method according to the invention;

FIG. 6 depicts schematically an embodiment of an assembly according to the invention;

FIG. 7 depicts a set of renders associated with the embodiment of the assembly as depicted in FIGS. 1-3 and the embodiment of a tool as depicted in FIG. 4;

FIG. 8 depicts a render of a plug module and locking element associated with the embodiment of the assembly as depicted in FIG. 6;

FIG. 9 depicts an embodiment of a luminaire according to the invention.

### DETAILED DESCRIPTION OF THE EMBODIMENTS

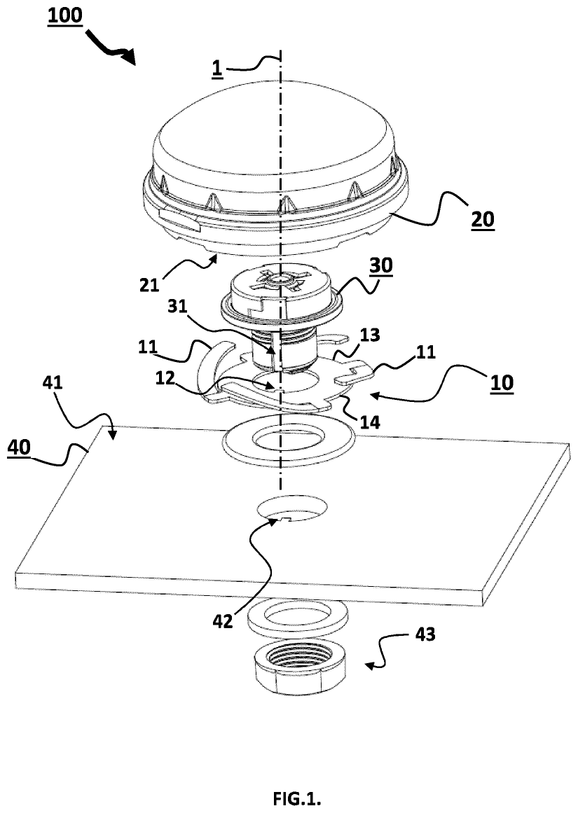

FIG. 1 depicts schematically, by non-limiting example, a perspective view of an assembly 100 according to the invention. Said perspective view is in exploded view.

FIG. 2 depicts schematically, by non-limiting example, a side view of said assembly 100. Said side view is in exploded view. FIG. 3 depicts schematically, by non-limiting example, a cross-sectional view of said assembly 100 when assembled.

The assembly 100 according to the invention comprises a lighting device 40, a socket 30, a plug module 20, and a locking element 10 according to the invention. The locking element 10 is configured to releasably lock the plug module 20 connected to the socket 30. The socket comprises a centerline 1. The assembly 100 is substantially arranged relative to said centerline 1. The lighting device 40 is not fully depicted, and FIGS. 1-3 only depict a part of a surface 41 of said lighting device 40. Said lighting device 40 may for example be a luminaire.

Referring to FIGS. 1-3, the socket 30 is a Zhaga socket. Alternatively, said socket may be a NEMA socket. The socket 30 is positionally fixed to the lighting device 40. The socket 30 is therefore secured and immovable relative to the lighting device 40. Hence, the lighting device 40 comprises (a surface 41 comprising) the socket 30. Here, by non-limiting example, the socket comprises a groove 31 in axial direction of the centerline 1 and the lighting device 40 comprises a protrusion 42. The socket 30 is thereby positionally fixed to the surface 41 of the lighting device 40 by means of said protrusion 42 interlocking said groove 31 when the socket 30 is mounted to the surface 41 of the lighting device 40 with a bolted connection (screw-mating a screw thread of the socket). Other alternative fixation mechanisms may be envisioned similarly. Such a groove 31 may be common for Zhaga sockets.

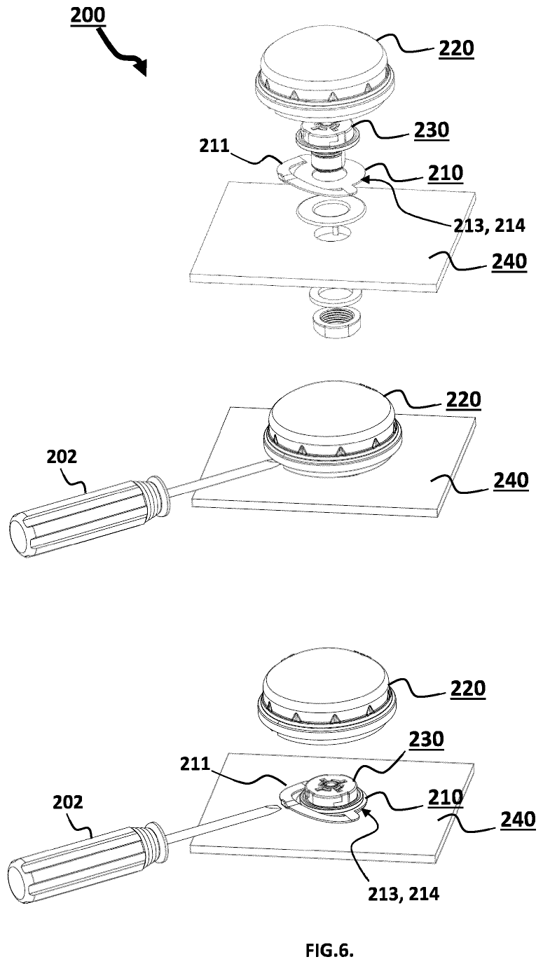

Referring to FIGS. 1-3, the plug module 20 is a Zhaga node. Alternatively, said plug module may be a NEMA node. Hence, the plug module 20 comprises a Zhaga plug (not referred to). The plug module 20 further comprises a base surface 21. Here, the base surface is circular 21. Hence, the base surface 21 is concentric with said socket 30 when the plug module 20 is connected to said socket 30. The base surface 21 is facing the surface 41 of the lighting device 40 when the plug module 20 is connected to said socket 30. The base surface 21 of the plug module 20 comprises a structure (not explicitly depicted in FIGS. 1-3). Said structure is seen, and referenced to by reference 22, in the render 1004 of the renders in FIG. 7.

Here, said structure is at least one rib extending in radial direction relative to the centerline 1. Said at least one rib is seen, and referenced to by reference 22, in the render 1004 of the renders in FIG. 7. The at least one rib is four ribs. Said ribs are evenly spaced relative to each other, and are therefore perpendicular to each other (i.e. at an angle 90 degrees relative to each other), and form a cross or crosshair shape. Said four ribs protrude from the base surface 21 of the plug module 20, and extend towards the surface 41 of the lighting device 40 when the plug module 20 is connected to the socket 30. In alternative examples, said at least one rib may be at least one groove, such as e.g. four grooves in the base surface of the plug module.

Still referring to FIGS. 1-3, the plug module 20 is mechanically connectable to the socket 30 with a press fit connection ensued by a rotational movement of the plug module 20 in a first rotational direction around the centerline 1 of the socket 30. Here, since the plug module 20 and the socket 30 are Zhaga compliant, said first rotational direction is a clockwise rotation when connecting the plug module 20 to the socket 30.

As mentioned, the assembly 100 also comprises a locking element 10 according to the invention. The locking element 10 is configured to releasably lock the plug module 20 when the plug module 20 is mechanically connected to the socket 30. Such a releasably locking prevents the plug module 20 to be freely disconnected, and thereby reduces the likelihood of theft. At the same time, said locking element enables an authorized party, comprising a tool and having knowledge about the locking element, to disconnect the plug module 20 from the socket 30 after being connected.

Still referring to FIGS. 1-3, the locking element 10 comprises a fastening means 12, a main body 13 and at least one spring plate 11. Here, the locking element 10 is a plate-shaped ring. The locking element 10 is concentric with the socket 30. Hence, the main body 13 of the locking element 10 comprises a circular inner aperture (not referred to) for receiving the socket 30. The socket 30 may thus protrude through said circular inner aperture, when the locking element 10 and the socket 30 are mounted/assembled to said lighting device 40. The diameter of said circular inner aperture may for example be at least 40 millimeters. Here, the locking element may comprise a plate thickness of most halve a millimeter.

As mentioned, the locking element 10 also comprises a fastening means 12. Here, the fastening means 12 is a protrusion 12 protruding towards the centerline 1 of the socket 30. Said protrusion matches the groove 31 of the socket 30 and interlocks therewith when the locking element 10 is mounted/assembled to said socket 30. Said groove may alternatively referred to as a slot. Therefore, the protrusion 12 is configured to constrain, when interlocked with said groove 31 of the socket 30, the rotation of the locking element 10 around the centerline 1 of the socket 30.

Alternatively, other fastening means may be envisioned to constrain a rotation of the locking element around the centerline of the socket. For example, the locking element may comprise an adhesive layer to adhere the locking element in a fixed position onto the surface of the lighting device; or via a press-fit connection to the socket.

Still referring to FIGS. 1-3, the main body 13 of the locking element 10 further comprises a circumference 14. Here, said circumference 14 is circular. The diameter of said circumference 14, relative to the centerline 1, may be at least 90 millimeters, for example to comply with a stay-out area of the Zhaga compliant plug module 20. Other values for said diameter may be envisioned similarly. Thus, said 90 millimeter is not necessary and merely exemplar.

As mentioned, the locking element 10 also comprises at least one spring plate 11. Here, said locking element 10 comprises four spring plates. Alternatively, said at least one spring plate may be one spring plate, or two spring plates, or at least three spring plates. Each spring plate of the at least one spring plate 11 is thereby coupled to the main body 13, and freely extending along a part of said circumference 14. Hence, the at least one spring plate 11 follows the contour set by the circumference 14. This also means that the at least one spring plate 11 is arranged at least 90 millimeters from said centerline.

Here, said freely extending along a part of said circumference 14 is freely extending along at most a quarter of said circumference 14, because there are four spring plates are evenly spaced along said circumference 14 of the main body 13. The number of four spring plates also matches the four ribs on the base surface 21 of the plug module 20. Still referring to FIGS. 1-3, the at least one spring plate 11 (i.e. each of the four spring plates) is deflectable between an initial position and a deflected position. The figures depict the spring plate in an initial position (i.e. at rest). The at least one spring plate 11 (i.e. each of the four spring plates) protrudes in the axial direction of the centerline 1. Hence, since the at least one spring plate 11 also extends along at most a quarter of said circumference, each spring plate of the at least one spring plate 11 may follow a helical-like path. Each spring plate of the at least one spring plate 11 may thereby be phrase as being under an angle relative to a plane enclosed by said circumference 14. For example, in the initial position said angle may be 45 degrees, while in the deflected position said angle may decrease from 45 degrees to 0 degrees. Said angle may be measured at the location where the spring plate is coupled to said main body.

Still referring to FIGS. 1-3, and as mentioned above, the locking element 10 is configured to releasably lock the plug module 20 connected to the socket 30. The working of the locking element 10 within said assembly 100 will now be described:

When the plug module 20 is being mechanically connected to the socket 30, as described above, each spring plate of the at least one spring plate 11 is configured to engage the base surface 21 of the plug module 20 and to deflect away from said initial position into the deflected position. This enables the rotational movement of the plug module 20 in the first rotational direction (i.e. clockwise direction described above). Hence, there is no hindrance to connect the plug module 20 to the socket 30.

However, when the plug module 20 is mechanically connected to the socket 30, each spring plate of the at least one spring plate 11 is configured to spring back to the initial position and to engage the structure (here, the radially extending ribs) of the base surface 21 of the plug module 20. This prevents a rotational movement of the plug module 20 in a second rotational direction opposite to the first rotational direction. Said second rotational direction is thus counterclockwise. Hence, the locking element 10 locks the plug module 20 into place after being mechanically connected to the socket 30.

Consequently, the locking element 10 locks the plug module 20 to the socket 30, because a disconnecting rotation of the plug module 20 in the second rotational direction is no longer possible. However, since the at least one spring plate 11 remains deflectable, another tool forcing or deflecting each spring plate of the at least one spring plate 11 may still release the plug module 20 from a locked position after being mechanically connected to the socket 30. The present invention therefore advantageously provides a locking element 10 that enables releasably locking of the plug module 20 connected to the socket 30. The plug module 20 cannot be disconnected from the socket 30 unless a tool is used to force or deflect each of the at least one spring plate 11.

Hence, in further aspects of the invention, the at least one spring plate 11 may be configured to receive a tool for deflecting each spring plate of the at least one spring plate 11 to the deflected position, so as to enable the rotational movement of the plug module 20 in the second rotational direction.

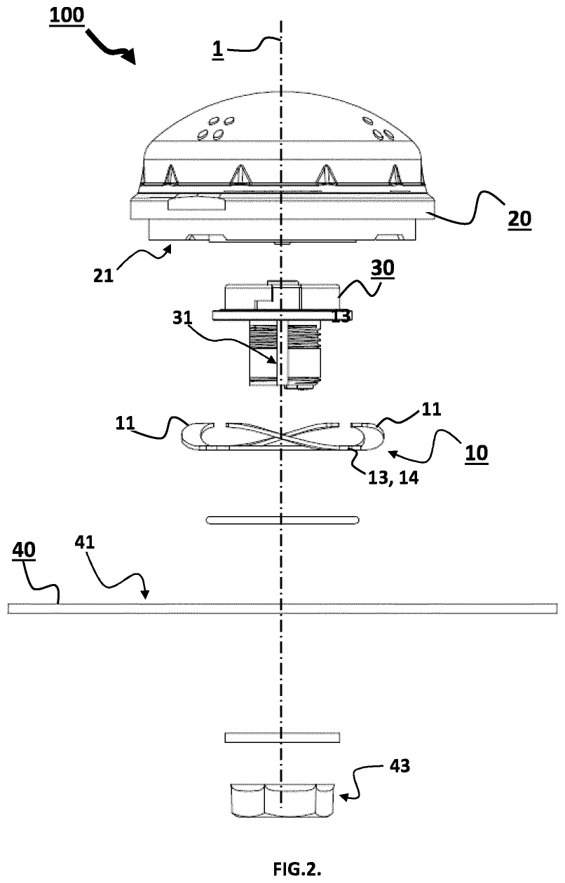

Referring to FIG. 4, a dedicated tool 50 is depicted schematically, by non-limiting example, that is unlocking the plug module 20 from the socket 30, after the plug module 20 being mechanically connected to the socket 30 and releasably locked by means of the locking element 10 according to the invention.

The dedicated tool 50 comprises at least one arm. In the present example, said tool 50 comprises four arms. Each respective arm is configured to engage, in operation, each respective spring plate of the four spring plates 11 of the locking element 10 simultaneously. Said engagement deflects each spring plate of the four spring plates 11 into the deformed position. As mentioned, in the deformed position of the at least one spring plate 11, the plug module 20 is not prevented, and enabled, to rotate freely in the counterclockwise direction so as to disconnect from the socket 30.

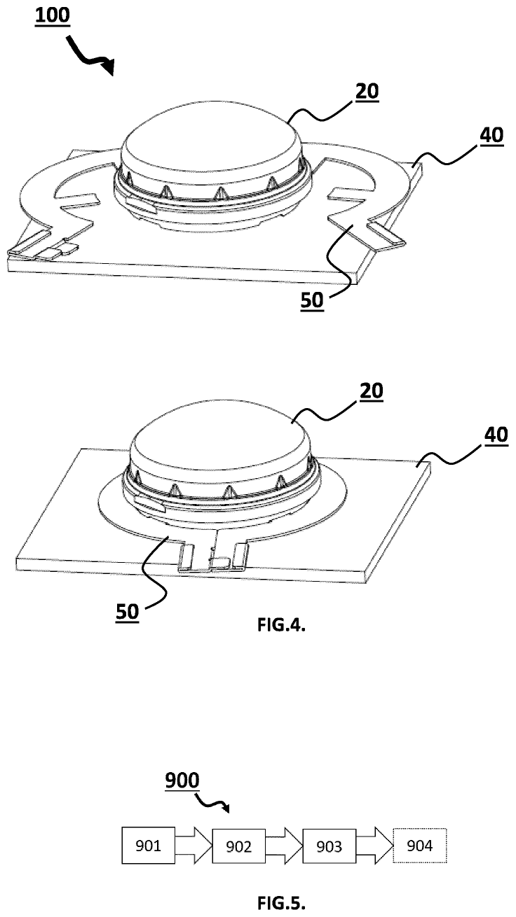

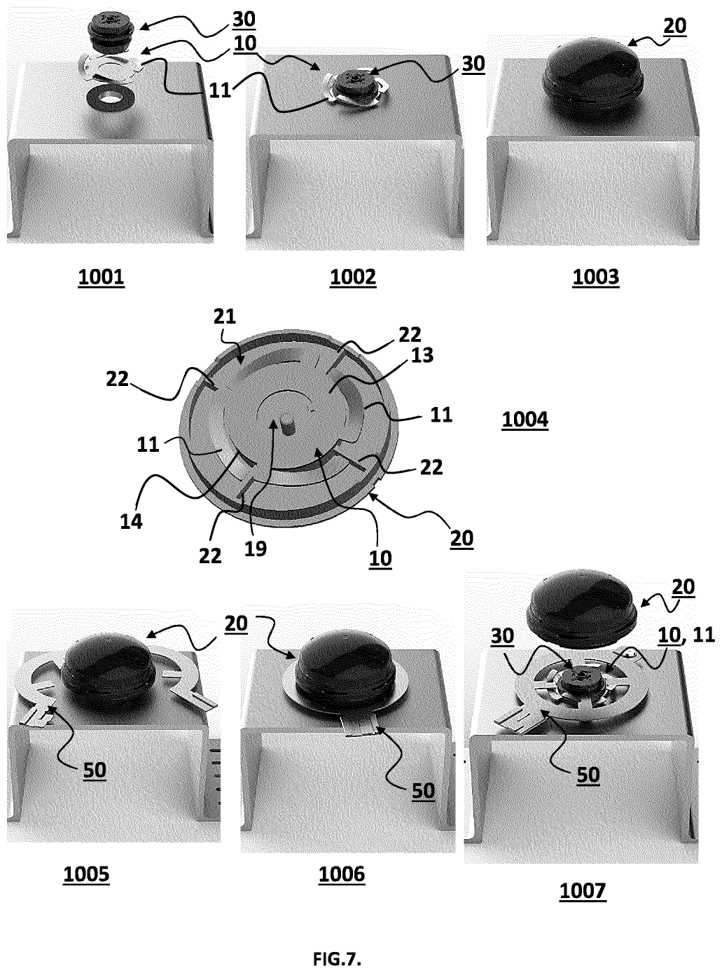

FIG. 6 depicts schematically, by non-limiting example, a perspective view of an embodiment of an assembly 200 according to the invention. FIG. 8 depicts schematically, by non-limiting example, a render 1009 of the base surface 221 of the plug module 220 according to this embodiment.

Said perspective view is in exploded view. The assembly 200 comprises a lighting device 240, a socket 230, a plug module 220, and a locking element 210, which are similar to the embodiment depicted in FIGS. 1-3, but only different in that the locking element 210 now comprises a single spring plate 211 engaging a different structure of the plug module 220.

Namely, the locking element 210 comprises a single spring plate 211. The spring plate 211 comprises an arc shape, and is connected to the main body 213 of the locking element 210 at a first location 2111 and a second location 2112. The first and second location are opposite to each other (i.e. antipodal) on the circumference 214 of the main body 213. In examples, said single spring plate 211 may additionally comprise a chamfered edge 2113, or protruding lip 2113, arranged to engage with a structure 222 of the base surface 211 of the plug module 220. The structure 22 is a set of ribs in radial direction, denoting a cavity, where said chamfered edge 2113 or said protruding lip as depicted 2113 may lock into, when the plug module 220 is mechanically connected to the socket, thereby preventing the plug module 220 to rotate in the second rotational direction.

The working of the locking element 210 is similar to the working of the locking element 10 as depicted in FIGS. 1-3. However, in the present assembly, since only one spring plate 211 is present, the tool for deflecting the spring plate 211 and thereby releasing the plug module 220 from a locked position may be a tool with a single arm to deflect the spring plate 211, such as a flat head screwdriver 202.

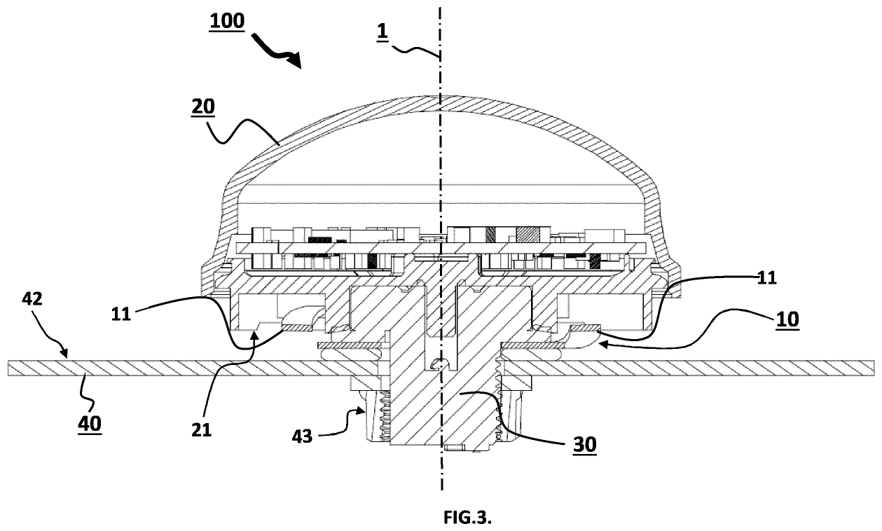

FIG. 5 depicts schematically, by non-limiting example, a method 900 of releasably locking a plug module connected to a socket with the locking element according to the invention. Thereby, the socket is positionally fixed and comprises a centerline; and the plug module is mechanically connectable to the socket with a press fit connection ensued by a rotational movement of the plug module in a first rotational direction around the centerline of the socket. The method 900 comprises a step 901 of constraining a rotation of the locking element around the centerline of the socket. The method comprises a step 902 of: when the plug module is being mechanically connected to the socket, the at least one spring plate of said locking element engaging a base surface of the plug module and deflecting away from said initial position into the deflected position, for enabling the rotational movement of the plug module in the first rotational direction. The method 900 comprises a step 903 of: when the plug module is mechanically connected to the socket, the at least one spring plate springing back to the initial position and engaging a structure of the base surface of the plug module, for preventing a rotational movement of the plug module in a second rotational direction opposite to the first rotational direction. The method 900 comprises an optional step 904: when the plug module is mechanically connected to the socket and the at least one spring plate is in the initial position, the at least one spring plate receiving a tool for deflecting the at least one spring plate to the deflected position, for enabling the rotational movement of the plug module in the second rotational direction.

FIG. 7 depicts schematically, by non-limiting example, a set of renders 1001, 1002, 1003 . . . 1006, 1007 of at least parts of the assembly 100 as depicted in FIGS. 1-3, and the associated releasing tool as depicted in FIG. 4.

Render 1001 and 1002 depict the locking element 10 integrated on a Zhaga connector 30. The locking element 10 comprises four spring plates 11. This construction may provide a significant locking force to prevent a plug module 20 being stolen when mechanically connected to said socket 30.

Render 1003 depicts a render of the plug module 20 mechanically connected to said connector 30 and locking element 10 as depicted in renders 1001 and 1002. Said plug module 20 is a Zhaga module.

Render 1004 depicts a render of the base surface 21 of said plug module 20. The base surface 21 comprises a structure 20. Here, by non-limiting example, as mentioned, said structure 22 consists of four ribs 22 extending in radial direction relative to the center of the plug module 20. The ribs 22 thereby form a crosshair shape. Said render 1004 also depicts the locking element 10, the main body 13 of the locking element 10 and the four spring plates 11 coupled to the circumference 14 of said main body 13. The main body 13 is circular and comprises a circular inner aperture 19.

Render 1004 depicts the locking element 10 and the plug module 20 as if in the initial position. Hence, the four spring plates 11 engage the four ribs 22 of the plug module 20, and thereby prevent a rotational movement of the plug module 20 in a second rotational direction opposite to the first rotational direction.

Render 1005, 1006, and 1007 depict releasing the plug module 20 after being mechanically connected to the socket 30 and locked by the locking element 10. Namely, the dedicated tool 50 comprises four respective arms 51 to deflect the four spring plates 11 simultaneously to the deflected position, such that the plug module 20 may be enabled to rotate in the second rotational direction and get disconnected from the socket 20.

More specifically, render 1005 depicts the plug module 20 mechanically connected to the socket 30, and the tool 50 being clamped around said plug module 20. In some alternative aspects, the plug module may comprise dedicated apertures, or grooves, to facilitate the arms of the tool to protrude inwards to reach the spring plates. Render 1006 and 1007 depicts the tool 50 simultaneously deflecting the four spring plates of the locking element 10 to the deflected position, by clamping the tool 50 and rotating the tool in the first rotational direction, such that the spring plates 11 no longer engage with the structure of the plug module 20, and such that the plug module 20 may be enabled to rotate in the second rotational direction and get disconnected from the socket 20.

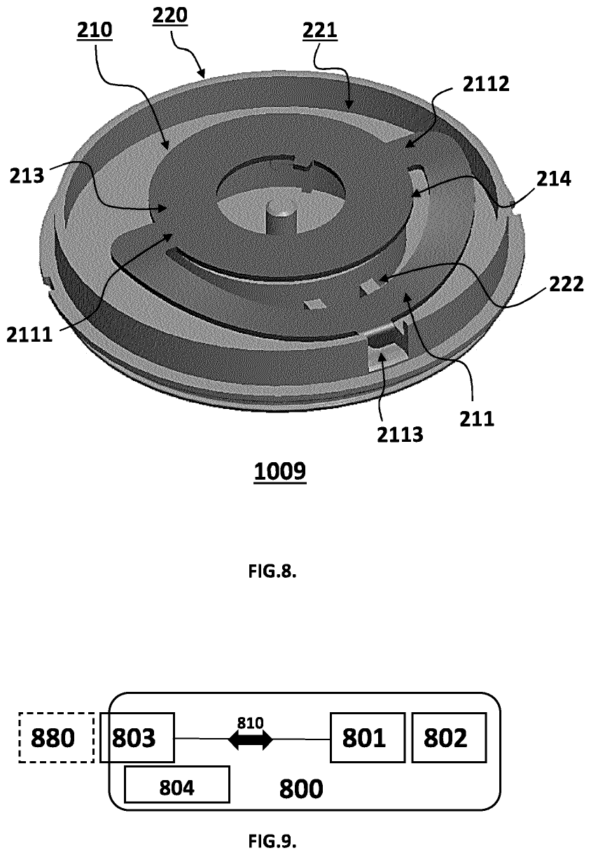

FIG. 9 depicts schematically, by non-limiting example, a luminaire 800 according to the invention. The luminaire comprises a luminaire surface. Said luminaire surface may for example be the luminaire housing. The luminaire 800 comprises a light source 802 for illumination. The luminaire 800 comprises a controller 801 for controlling said light source 802 to provide illumination based on control signals 810. The luminaire 800 further comprises a socket 803 for mechanically connecting to a plug module 880. The plug module 880 is a Zhaga module. Here, said plug module 880 is a sensor module. When the plug module 880 is connected to the socket 803, the socket 803 conveys control signals between the plug module 880 and the controller 801. The controller 801 is configured to control the light source 802 at least partly based on the control signals 810. To prevent the plug module 880 to be disconnected during operation of the luminaire 800, which may be undesired, the luminaire 800 further comprises a locking element 804 according to the present invention. The locking element 804 is configured to releasably lock the plug module 880 connected to the socket 803. The socket may be a Zhaga or NEMA socket. The plug module may be a Zhaga or NEMA compliant module.

1. An assembly comprising a lighting device, a socket, a plug module, and a locking element for releasably locking the plug module connected to the socket;
wherein the socket is positionally fixed to said lighting device and comprises a centerline;
wherein the plug module comprises a base surface comprising a structure;
wherein the plug module is configured to mechanically connect to the socket with a press fit connection ensued by a rotational movement of the plug module in a first rotational direction around the centerline of the socket;
wherein the locking element comprises:
a fastening means configured to constrain a rotation of the locking element around the centerline of the socket;
a main body comprising a circumference;
at least one spring plate coupled to the main body and freely extending along a part of said circumference;
wherein the at least one spring plate is deflectable between an initial position and a deflected position, wherein in the initial position the at least one spring plate protrudes in the axial direction of the centerline;
wherein, when the plug module is being mechanically connected to the socket, the at least one spring plate of the locking element is configured to engage the base surface of the plug module and to deflect away from said initial position into the deflected position, so as to the rotational movement of the plug module in the first rotational direction;
wherein, when the plug module is mechanically connected to the socket, the at least one spring plate of the locking element is configured to spring back to the initial position and to engage the structure of the base surface of the plug module, so as to prevent a rotational movement of the plug module in a second rotational direction opposite to the first rotational direction.

2. The assembly according to claim 1, wherein, when the plug module is mechanically connected to the socket and the at least one spring plate is in the initial position, the at least one spring plate is configured to receive a tool for deflecting the at least one spring plate to the deflected position, so as to enable the rotational movement of the plug module in the second rotational direction.

3. The assembly according to claim 1, wherein the socket is a Zhaga socket and the plug module is a Zhaga node.

4. The assembly according to claim 1, wherein the main body comprises the fastening means, wherein the fastening means is a protrusion protruding towards the centerline of the socket, wherein the protrusion is configured to constrain, when interlocked with a slot of the socket, the rotation of the locking element around the centerline of the socket.

5. The assembly according to claim 1, wherein the main body is a plate-shaped ring.

6. The assembly according to claim 1, wherein the at least one spring plate comprises a plurality of spring plates evenly spaced around the circumference of the main body.

7. The assembly according to claim 1, wherein the at least one spring plate comprises four spring plates.

8. The assembly according to claim 1, wherein the main body comprises a circular inner aperture arranged to receive said socket, wherein a diameter of said circular inner aperture is at least 40 millimeters.

9. The assembly according to claim 1, wherein the at least one spring plate is arranged at least 90 millimeters from said centerline.

10. The assembly according to claim 1, wherein said part of said circumference is at most a quarter of said circumference.

11. A method of releasably locking a plug module connected to a socket with a locking element;
wherein the socket is positionally fixed and comprises a centerline;
wherein the plug module is mechanically connectable to the socket with a press fit connection ensued by a rotational movement of the plug module in a first rotational direction around the centerline of the socket;
wherein the locking element comprises:
a fastening means configured to constrain a rotation of the locking element around the centerline of the socket;
a main body comprising a circumference;
at least one spring plate coupled to the main body and freely extending along a part of said circumference;
wherein the at least one spring plate is deflectable between an initial position and a deflected position, wherein in the initial position the at least one spring plate protrudes in the axial direction of the centerline;
wherein the method comprises:
constraining a rotation of the locking element around the centerline of the socket;
when the plug module is being mechanically connected to the socket, the at least one spring plate of said locking element engaging a base surface of the plug module and deflecting away from said initial position into the deflected position, for enabling the rotational movement of the plug module in the first rotational direction;
when the plug module is mechanically connected to the socket, the at least one spring plate springing back to the initial position and engaging a structure of the base surface of the plug module, for preventing a rotational movement of the plug module in a second rotational direction opposite to the first rotational direction.

12. The method according to claim 11, the method further comprising:
when the plug module is mechanically connected to the socket and the at least one spring plate is in the initial position, the at least one spring plate receiving a tool for deflecting the at least one spring plate to the deflected position, for enabling the rotational movement of the plug module in the second rotational direction.

13. A luminaire comprising a light source, a controller, a luminaire surface, a socket and a locking element;
wherein said socket is positionally fixed on the luminaire surface and comprises a centerline;
wherein said socket is arranged for mechanically connecting to a plug module; wherein the socket is configured to connect to a plug module and convey control signals between the plug module and the controller;
wherein the controller is configured to control the light source based on the control signals;
wherein the locking element is configured to releasably lock the plug module connected to the socket for preventing disconnection of the plug module and ensuring the control signals to be conveyed;
wherein the locking element comprises:
a fastening means configured to constrain a rotation of the locking element around the centerline of the socket;
a main body comprising a circumference;
at least one spring plate coupled to the main body and freely extending along a part of said circumference;
wherein the at least one spring plate is deflectable between an initial position and a deflected position, wherein in the initial position the at least one spring plate protrudes in the axial direction of the centerline;
wherein, when the plug module is being mechanically connected to the socket, the at least one spring plate is configured to engage a base surface of the plug module and to deflect away from said initial position into the deflected position, so as to enable the rotational movement of the plug module in the first rotational direction;
wherein, when the plug module is mechanically connected to the socket, the at least one spring plate is configured to spring back to the initial position and to engage a structure of the base surface of the plug module, so as to prevent a rotational movement of the plug module in a second rotational direction opposite to the first rotational direction.

14. (canceled)
